(19) United States
(12) Patent Application Publication
(10) Pub. No.: US 2019/0317267 A1
(43) Pub. Date: Oct. 17, 2019

(54) LIGHTING DEVICE AND DISPLAY DEVICE

(71) Applicant: SHARP KABUSHIKI KAISHA, Sakai City (JP)

(72) Inventor: SHIHOMI NAKAO, Sakai City (JP)

(21) Appl. No.: 16/377,773

(22) Filed: Apr. 8, 2019

(30) Foreign Application Priority Data
Apr. 11, 2018 (JP) 2018-076080

(51) Int. Cl. F21V 8/00

(52) U.S. Cl. CPC G02B 6/0045; G02B 6/0088; G02B 6/0013

(57) ABSTRACT

A lighting device includes a light source and a light guide plate including a light source opposed surface through which light from the light source enters and a pair of plate surfaces through one of which the light exits. The light source is opposed to a middle portion of the light source opposed surface with respect to a longitudinal direction thereof. The light source opposed surface has a light entry portion through which the light from the light source enters at a portion opposed to the light source and a non-light entry portion through which the light from the light source does not enter at a portion on either side of the light entry portion. The light guide plate has a shape such that a dimension thereof parallel to the longitudinal direction of the light source opposed surface is decreased as it is farther away from the light source.

### CROSS REFERENCE TO RELATED APPLICATION

This application claims priority from Japanese Patent Application. No. 2018-76080 filed on. Apr. 11, 2018. The entire contents of the priority application are incorporated herein by reference.

### TECHNICAL FIELD

The technology described herein relates to a lighting device and a display device including the lighting device.

### BACKGROUND

There is known an example of a lighting device included in a display device. The lighting device includes a light source and a light guide plate, and is configured such that light from the light source enters the light guide plate through a portion of the outer peripheral end surface of the light guide plate opposed to the light source and the light exits through either one of a pair of plate surfaces to illuminate a target to be illuminated The lighting device is characterized in that a part of the light guide plate is projected and a reflecting member is provided at the portion to transmit light to the corner portion of the light guide plate. An example of such a device is disclosed in Japanese Unexamined Patent Application Publication No. 2014-142590.

Conventional lighting devices including the device described above have a problem that the luminance of emitted light is lower at a position distant from the entry portion of the light from the light source than at a position near the entry portion of the light from the light source.

### SUMMARY

The technology described herein was made in view of the above circumstances. An object is to provide a lighting device with suppressed uneven luminance and a display device with high display quality.

A lighting device according to the technology described herein includes a light source and a light guide plate including an outer peripheral surface a part of which is a light source opposed surface that is opposed to the light source and through which light from the light source enters and including a pair of plate surfaces through one of which the light exits. The light source is disposed to be opposed to a middle portion of the light source opposed surface with respect to a longitudinal direction thereof. The light source opposed surface has a light entry portion through which the light from light source enters at a portion opposed to the light source and a non-light entry portion through which the light from the light source does not enter at a portion on either side of the light entry portion. The light guide plate has a shape such that a dimension thereof that is parallel to the longitudinal direction of the light source opposed surface is decreased as it is farther away from the light source.

The thus configured lighting device can disperse the light entered through the light entry portion of the light guide plate into the regions of the non-light entry portion on the both sides of the light entry portion. The regions where light is dispersed are narrowed with increasing distance from the light source, which makes it possible to suppress uneven luminance due to the distance from the light source and make uniform the luminance of the light emitted through the light guide plate. In addition, a display device included in the lighting device in this configuration provides high display quality because the luminance of the light in the display area of a display panel is made uniform.

According to the technology described herein, it is possible to provide a lighting device with suppressed uneven luminance and a display device with high display quality.

### BRIEF DESCRIPTION OF THE DRAWINGS

FIG. 1 is a cross-sectional view of a display device of a first embodiment.

FIG. 2 is a plan view of a lighting device illustrated in FIG. 1.

FIG. 3 is a plan view of a lighting device included in a display device of a second embodiment.

FIG. 4 is a plan view of a lighting device included in a display device of a modification example of the second embodiment.

FIG. 5 is a plan view of a lighting device included in a display device of another modification example of the second embodiment.

FIG. 6 is a plan view of a lighting device included in a display device of still another modification example of the second embodiment.

### DETAILED DESCRIPTION

Hereinafter, some embodiments of the technology described herein will be described in detail with reference to the drawings as examples for carrying out the technology described herein. It is to be noted that the technology described herein is not limited to the following embodiments, but can be implemented in various modes with various modifications and improvements based on knowledge of those skilled in the art.

### FIRST EMBODIMENT

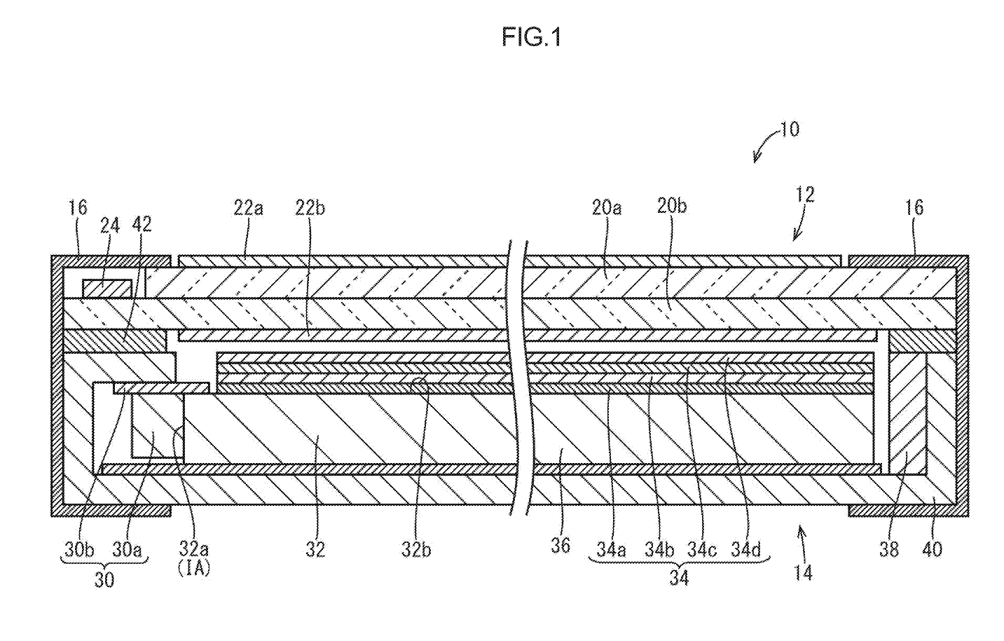

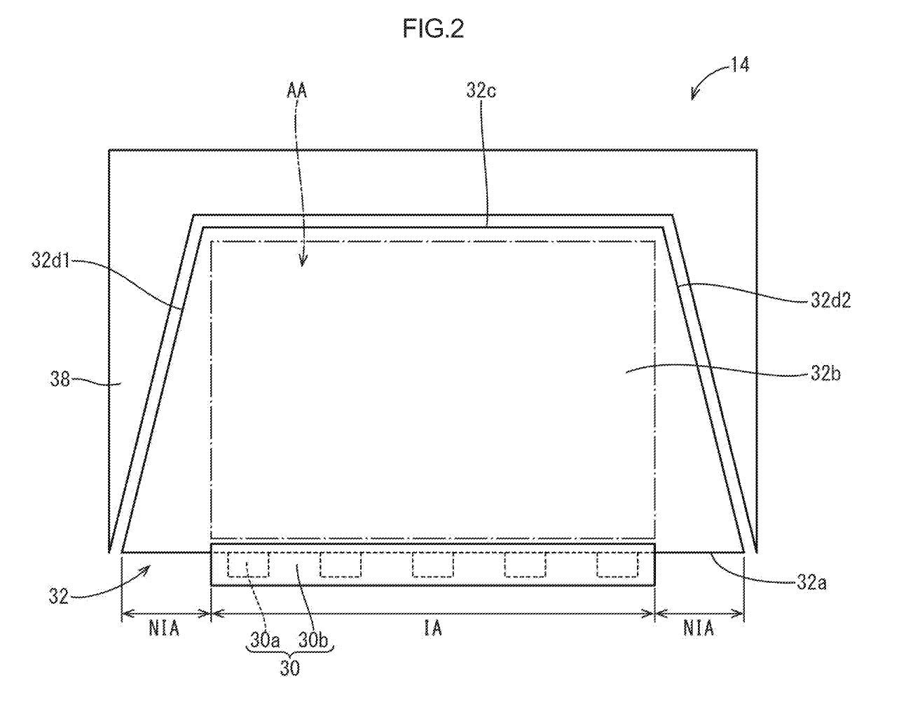

A liquid crystal display device 10 as a display device of a first embodiment of the technology described herein is illustrated in the cross-sectional view of FIG. 1. The liquid crystal display device 10 has landscape square shape as a whole (see FIG. 2). The liquid crystal display device 10 includes a liquid crystal panel 12 as a display panel configured to display an image and a backlight device 14 as a lighting device of the technology described herein for irradiating the liquid crystal panel 12 with light for image display. The liquid crystal panel 12 and the backlight device are stacked and integrated with each other by sticking a light-shielding tape 16 across the liquid crystal panel 12 and the back tight device 14 along the outer periphery thereof. Although the liquid crystal display device 10 of the technology described herein is used for a television or a PC display, for example, the use of the liquid crystal display device 10 is not limited to this, and the display device of the technology described herein can also be used in portrait display devices such as portable information terminals including a smartphone.

The liquid crystal panel 12 has a pair of substrates 20a and 20b which are substantially transparent and have excellent light-transmissive property. Of the pair of substrates 20a and 20b, the upper side (front side) is the CF substrate 20a and the lower side (back side) is the array substrate 20b. A pair of polarizing plates 22a and 22b is stuck to the outer surfaces of the pair of substrates 20a and 20b. The liquid crystal panel 12 is formed by bonding together the pair of substrates 20a and 20b with a predetermined gap therebetween. The liquid crystal panel 12 includes a liquid crystal layer that is sandwiched between the pair of substrates 20a and 20b and includes liquid crystal molecules as a substance changing in the optical characteristics due to application of an electric field, and a sealing portion that surrounds the liquid crystal layer and seals the liquid crystal layer (neither of which is illustrated). One end portion of the array substrate 20b along the long side protrudes to the outside from the CF substrate 20a, and an LCD controller 24 for controlling the liquid crystal panel 12, for example, is mounted on the protruding portion

An internal structure of the liquid crystal panel 12 will be briefly described. On the inner surface of the array substrate 20b, large numbers of thin film transistors (TFTs) as switching elements and pixel electrodes are provided in a matrix arrangement. On the inner surface of the array substrate 20b, lattice-like gate line and source line surround the TFT and the pixel electrodes. Image-related signals are transmitted to the gate line and the source line. On the other hand, on the inner surface of the CF substrate 20a, a large number of color filters are provided at positions corresponding to the pixel electrodes. The color filters are alternately arranged such that three colors of R, G, and B are aligned. A light-shielding portion (black matrix) 26 is provided on the inner surface of the CF substrate 20a to prevent color mixture between the adjacent color filters. The light-shielding portion 26 is formed in a lattice shape to partition the adjacent color filters in a display area AA in the center of the liquid crystal panel 12. In contrast, a non-display area NIA on the outer peripheral portion of the liquid crystal panel 12 is formed. in a solid manner.

The backlight device 14 is disposed on the back side (flat surface side) of the liquid crystal panel 12. The backlight device 14 includes a light source 30, a rectangular plate-like light guide plate 32 for guiding light from the light source 30, an optical sheet 34 disposed on the front side of the light guide plate 32, a light reflection sheet 36 disposed on the back side of the light guide plate 32, a plastic chassis 38 as a frame surrounding the light guide plate 32 and the optical sheet 34 (hereinafter simply referred to as “chassis 38”), and a bezel 40 that houses the light source 30, the light guide plate 32, the optical sheet 34, and the chassis 38. The backlight device 14 is a backlight device of an edge light type (or a side light type) in which the light from the light source 30 enters only through one side of the light (guide plate 32. The light source 30 is disposed on one of a pair of end portion sides along the long side of the backlight device 14.

The light source 30 includes light emitting diodes (LEDs) 30a and an LED substrate 30b on which the LEDs 30a are mounted. Each of the LEDs 30a is formed by sealing an LED chip with a sealing material. In each of the LEDs 30a, the LED chip is supposed to emit single blue light, for example, but actually emits white light as a whole because a phosphor (yellow phosphor, green phosphor, or red phosphor) is dispersed and blended in the sealing material. The configuration of the LEDs 30a is not limited to this, and can be changed as appropriate. The LED substrate 30b is made of an insulating material and has a flexible film shape (sheet shape). On the LED substrate 30b, the LEDs 30a are mounted with spacing therebetween. The LEDs 30a are arranged at equal intervals, for example, but the technology described herein is not limited thereto.

The light guide plate 32 is made of a substantially transparent synthetic resin material (for example, an acrylic resin such as PMMA or polycarbonate), and is sufficiently higher in refractive index than the air. Since the technology described herein is characterized by the shape of the light guide plate 32 and the positional relationship with the light source, the light guide plate 32 will be described here not in detail but briefly. As illustrated in FIG. 2, one of the outer peripheral end surfaces of the four sides of the light guide plate 32 constitutes a light source opposed surface 32a that is disposed to be opposed to the light source 30. The light source opposed surface 32a linearly extends along the arrangement direction of the LEDs 30a (see FIG. 2). Then, the light emitted from the light source 30 is introduced into the light guide plate 32 through a part of the light source opposed surface 32a. On the other hand, out of the pair of plate surfaces of the light guide plate 32, the plate surface facing the front side (the liquid crystal panel 12 side) constitutes a light emission surface 32b, and the light introduced into the light guide plate 32 is propagated inside and is emitted through the light emission surface 32b toward the optical sheet 34.

The optical sheet 34 is interposed between the liquid crystal panel 12 and the light guide plate 32 to allow light to be emitted through the light guide late 32 toward the liquid crystal panel 12 while exerting a predetermined optical effect on the light. The optical sheet 34 includes sheets overlapping together. Specifically, in the present embodiment, the optical sheet 34 includes four sheets of a first diffusion sheet 34a, a first prism sheet 34b, a second prism sheet 34c, and a second diffusion sheet 34d in this order from the back side. Each of the first diffusion sheet 34a and the second diffusion sheet 34d is formed such that a large number of diffusing particles are dispersed in a substantially transparent synthetic resin base material and have a function of diffusing transmitted light. Each of the first prism sheet 34b and the second prism sheet 34c is formed such that a large number of prisms extending in one direction are aligned on a plate surface of a substantially transparent synthetic resin base material. These sheets selectively exert the light condensing action in the alignment direct on of the prisms. The first prism sheet 34b and the second prism sheet 34c are arranged such that their prisms are orthogonal to each other. The type and number of the sheets constituting the optical sheet 34 can be changed as appropriate.

The light reflection sheet 36 is excellent in light reflectivity and has a function of reflecting light leaking from the plate surface of the light guide plate 32 on the side opposite to the light emission surface 32b toward the front side. The chassis 38 is made of a synthetic resin (for example, polycarbonate) whose surface is white, and is arranged on the outer peripheral side of the light guide plate 32 to surround a portion of the light guide plate 32 excluding the light source opposed surface 32a. The bezel 40 is metallic (for example, aluminum) and is not light transmissive. The liquid crystal panel 12 is fixed to the chassis 38 and the bezel 40 via a fixing tape 42 having a light shielding property to overlap the emission surface 32b of the light guide plate 32, and is configured to display an image using the light emitted through the light emission surface 32b.

Next, the light guide plate 32 will be described here in detail. As illustrated in the plan view of FIG. 2 (the optical sheet 34 and the bezel 40 are not illustrated), the light guide plate 32 is trapezoidal in a plan view. Specifically, out of the outer peripheral surfaces of the light guide plate 32, the bottom surface constitutes the light source opposed surface 32a described above, and the top surface constitutes a light source opposite surface 32c on the side opposite to the light source 30, which is parallel to the light source opposed surface 32a and is shorter than the light source opposed surface 32a. In addition, the light source opposed surface 32a and the source opposite surface 32c are coupled together by a pair of coupling surfaces 32d1 and 32d2. Each of the pair of coupling surfaces 32d1 and 32d2 connects linearly the end portion of the light source opposed surface 32a and the end portion of the light source opposite surface 32c in a plan view, and each of the pair of coupling surfaces 32d1 and 32d2 is formed from a single plane connecting them. In the present embodiment, the light guide plate 32 has a line-symmetrical shape, that is, an isosceles trapezoidal shape with respect to a straight line passing through the midpoint of the light source opposed surface 32a and the midpoint of the light source opposite surface 32c in a plan view. Therefore, the light guide plate 32 formed such that the dimension of the light guide plate 32 as seen in the direction parallel to the longitudinal direction of the light source opposed surface 32a becomes smaller with increasing distance from the light source 30.

The light source 30 is disposed to be opposed to a central portion of the light guide plate 32 as seen in the longitudinal direction of the light source opposed surface 32a, in other words, in the extending direction of the outer peripheral surface. That is, the light from the light source is entered only through the central portion of the light source opposed surface 32a as seen in the longitudinal direction. Therefore, the central portion of the light source opposed surface 32a as seen in the longitudinal direction constitutes a light entry portion IA into which the light from the light source 30 is entered, and portions on both sides of the light entry portion IA constitute non-light entry portions NIA which no light from the light source 30 is entered.

The light emission surface 32b of the light guide plate 32 is trapezoidal in shape, whereas the display area AA of the display panel 12 is rectangular in shape. The length along the long side of the display area AA (as seen in the horizontal direction in FIG. 2) is substantially equal to the length of the light source opposite surface 32c of the light guide plate 32 and the length of the light entry portion IA of the light source opposed surface 32a. In other words, the non-light entry portions NIA of the light source opposed surface 32a are configured not to overlap the portion of the light emission surface 32b corresponding to the display area AA as viewed from the light source 30.

The inner peripheral surface of the chassis 38 has a shape along the light source opposite surface 32c and the pair of coupling surfaces 32d1 and 32d2 of the light guide plate 32. On the other hand, the outer shape of the chassis 38 is rectangular in conformity with the bezel 40. That is, the chassis 38 is a member that fills the gap between the light guide plate 32 and the bezel 40. Therefore, the light guide plate according to the technology described herein can be mounted on a device of any shape owing to the presence of the chassis.

In the thus configured backlight device 14, the light guide plate 32 has a trapezoidal shape in which the light source 30 side expanded to the outside of the portion configured to allow fight to exit from the display area AA as described above, so that the light from the light source 30 entered through the light entry portion IA of the light guide plate 32 can be dispersed in the regions outside the portion configured to allow light to exit from the display area AA. In the light guide plate 32, the regions where light is dispersed are narrower with increasing distance from the light source 30. This makes it possible to suppress uneven luminance due to the distance from the light source 30 and make uniform the luminance of the light exiting the light guide plate 32. In addition, the liquid crystal display device 10 provides high display quality because the luminance of the light in the display area AA of the liquid crystal panel 12 is made uniform.

### SECOND EMBODIMENT

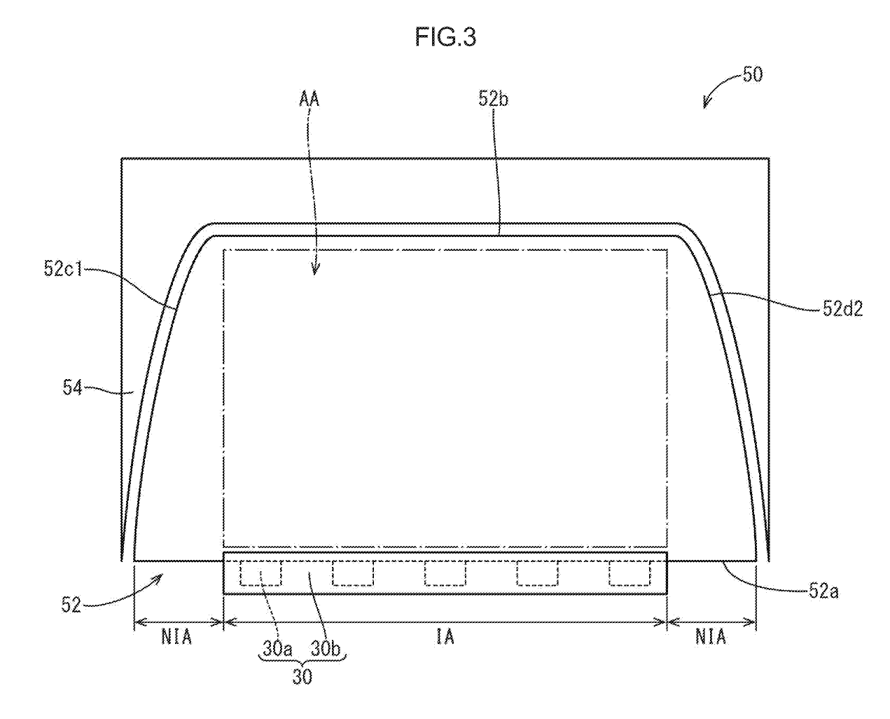

FIG. 3 illustrates a plan view (the optical sheet and the bezel are not illustrated) of a backlight device 50 included in the display device of a second embodiment. In the display device of the present embodiment, some components of the display device other than the backlight device 50 and some components of the backlight device 50 are the same in configuration as those of the liquid crystal display device 10 of the first embodiment, and thus description thereof will be omitted and the same components will be given the same reference numerals.

The backlight device 50 in the second embodiment is different from the backlight device 14 in the first embodiment in the shape of the light guide plate. A light guide plate 52 of the backlight device 50 is similar to the light guide plate 32 of the first embodiment and is generally trapezoidal in a plan view. More specifically, a light source opposed surface 52a opposed to a light source 30 is longer than a light source opposite surface 52b opposite to the light source 30 and is parallel to the light source opposite surface 52b. However, a pair of coupling surfaces 52c1 and 52c2 connecting end portions of the light source opposed surface 52a and end portions of the light source opposite surface 52b is formed not in a planar shape linearly connecting the end portions in a plan view as in the light guide plate 32 of the first embodiment, but in a curved shape bulging outward from the plane. The backlight device 50 in the present embodiment also includes a plastic chassis 54 as a frame similarly to the backlight device 14 in the first embodiment. The backlight device 50 has a rectangular outer shape according to a bezel 40, and has an inner peripheral surface shaped along the light source opposite surface 52b and the pair of coupling surfaces 52c1 and 52c2 of the light guide plate 52.

The backlight device 50 in the present embodiment is configured similarly to the backlight device 14 in the first embodiment, such that from the light source 30 is entered only through a central portion of the light source opposed surface 52a as seen in the longitudinal direction. That is, the central portion of the light source opposed surface 52a as seen in the longitudinal direction constitutes a light entry portion IA into which the light from the light source 30 is entered, and portions on both sides of the light entry portion IA constitute non-light entry portions NIA into which no light from the light source 30 is entered.

Therefore, also in the backlight device 50 of the present embodiment, the light guide plate 52 is shaped such that the light source 30 side is expanded to the outside of the portion configured to allow light to exit from the display area AA, so that the light from the light source 30 entered through the light entry portion IA of the light guide plate 52 can be dispersed in the regions outside the portion configured to allow light to exit from the display area AA. In the light guide plate 52, the regions where light is dispersed are narrower with increasing distance from the light source 30. This makes it possible to suppress uneven luminance due to the distance from the light source 30 and make uniform the luminance of the light exiting the light guide plate 52. In the backlight device 50 of the present embodiment, the angle formed between the pair of coupling surfaces 52c1 and 52c2 of the light guide plate 52 and the light source opposed surface 52a is larger with increasing proximity to the light source opposed surface 52a. Therefore, the light can be reflected by the coupling surfaces 52c1 and 52c2 inside the light guide plate 52 toward the light source opposite surface 52b. This ensures the brightness in the region close to the light source opposite surface 52b in the display area AA and further suppresses uneven luminance due to the distance from the light source 30.

In addition, the liquid crystal display device in the present embodiment provides high display quality because the luminance of the light in the display area AA of the liquid crystal panel 12 is made uniform.

### MODIFICATION EXAMPLE

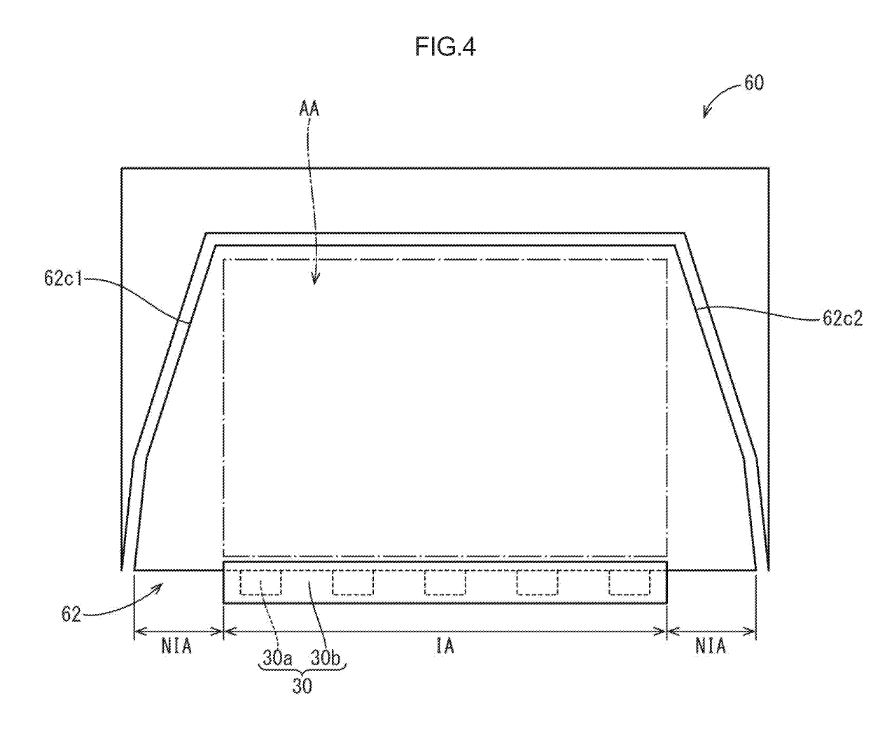

In the backlight device 50 according to the second embodiment, the pair of coupling surfaces 52c1 and 52c2 of the light guide plate 52 is formed in a curved shape bulging outward from a plane linearly connecting the end portions in a plan view, so that the angle formed with the light source opposed surface 52a is larger with increasing proximity to the light source opposed surface 52a. In a backlight device 60 according to a modification example illustrated in FIG. 4, a pair of coupling surfaces 62c1 and 62c2 of a light guide plate includes flat surfaces, so that the angle formed with a source opposed surface 52a is changed stepwise. Also in this modification example, it is possible to obtain the same advantageous effects as those of the second embodiment.

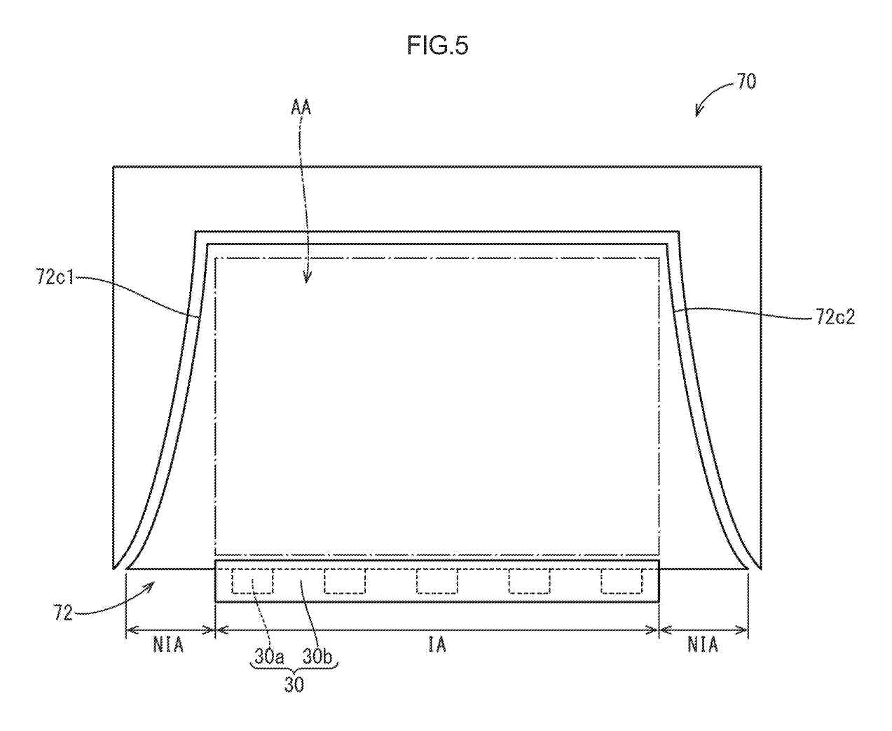

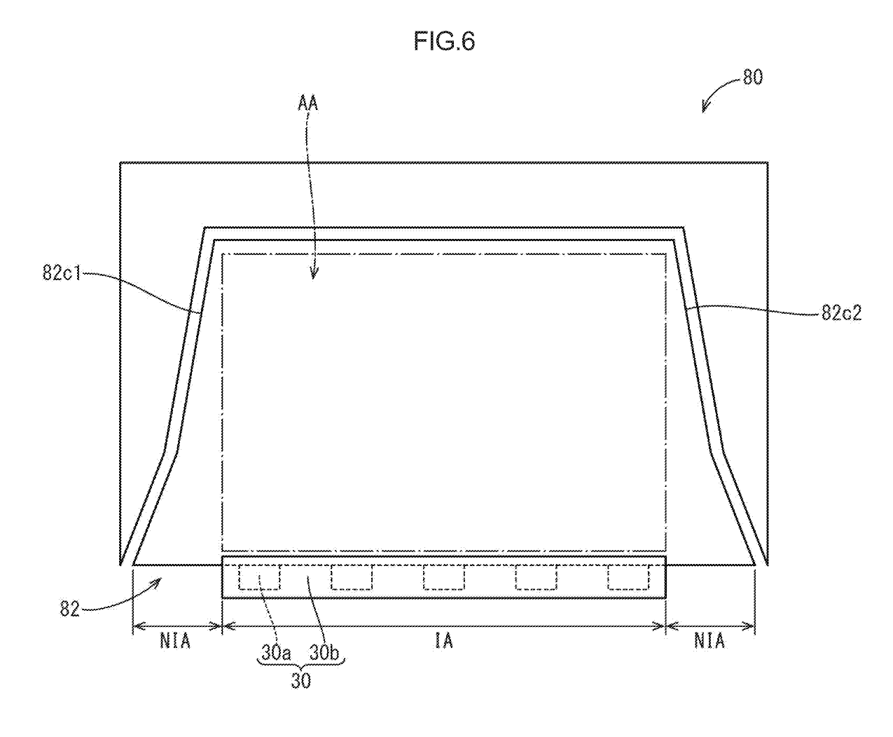

In the backlight device 50 of the second embodiment and the backlight device 60 of the modification example, the pair of coupling surfaces of the light guide plate is shaped to bulge outward from a plane linearly connecting the end portions in a plan view. Alternatively, the pair of coupling surfaces may be formed in a shape recessed inward from the plane linearly connecting the end portions in a plan view. In other words, the pair of coupling surfaces may be shaped such that the angle formed with the light source opposed surface is smaller with increasing proximity to the light source opposed surface. In a backlight device 70 illustrated in FIG. 5, a pair of coupling surfaces 72c1 and 72c2 of a light guide plate is formed in a curved shape. In a backlight device 80 illustrated in FIG. 6, a pair of coupling surfaces 82c1 and 82c2 of a light guide plate 82b includes flat surfaces, so that the angle formed with a light source opposed surface 52a is changed stepwise.

1. A lighting device comprising:
a light source; and
a light guide plate including an outer peripheral surface a part of which is a light source opposed surface that is opposed to the light source and through which light from the source enters and including a pair of plate surfaces through one of which the light exits, wherein
the light source is disposed to be opposed to a middle portion of the light source opposed surface with respect to a longitudinal direction thereof,
the light source opposed surface has a light entry portion through which the light from the light source enters at a portion opposed to the light source and a non-light entry portion through which the light from the light source does not enter at a portion on either side of the light entry portion, and
the light guide plate has a shape such that a dimension thereof that is parallel to the longitudinal direction of the source opposed surface is decreased as it is farther away from the light source.

2. The lighting device according to claim 1, wherein the light guide plate has a shape that is line-symmetric with respect to an axis orthogonal to the light source opposed surface as viewed from a direction orthogonal to the plate surface.

3. The lighting device according to claim 1, wherein the light guide plate has a part of the outer peripheral surface as a light source opposite surface that is opposite from the light source opposed surface and parallel to the light source opposed surface.

4. The lighting device according to claim 3, wherein
the light guide plate includes a part of the outer peripheral surface as a coupling surface that connects the light source opposed surface and the light source opposite surface, and
the coupling surface is formed from a single plane surface connecting the light source opposed surface and the light source opposite surface.

5. The lighting device according to claim 3, wherein
the light guide plate includes a part of the outer peripheral surface as a coupling surface that connects an end portion of the light source opposed surface and an end portion of the light source opposite surface, and
the coupling surface is shaped to bulge outward from a plane connecting the light source opposed surface and the light source opposite surface as viewed from a direction orthogonal to the plate surface.

6. The lighting device according to claim 1, further comprising a frame that is provided on an outer peripheral side of the light guide plate and reflects at least part of light rays leaking from an outer peripheral portion of the light guide plate toward the light guide plate and has an inner peripheral surface thereof extending along the outer peripheral surface of the light guide plate.

7. The lighting device according to claim 1, wherein a plurality of the light sources is arranged in parallel along the light entry portion of the light source opposed surface.

8. A display device comprising:
the lighting device according to claim 1; and
a display panel that displays an image using light from the lighting device.

9. The display device according to claim 8, wherein the non-light entry portion is configured not to overlap a portion of the light guide plate configured to emit light to a display area of the display panel as viewed from the light source.
